(19) United States
(12) Patent Application Publication
(10) Pub. No.: US 2014/0136219 A1
(43) Pub. Date: May 15, 2014

(54) PATIENT AND PHYSICIAN GATEWAY TO CLINICAL DATA

(71) Applicant: Keat Jin Lee, Guilford, CT (US)

(72) Inventor: Keat Jin Lee, Guilford, CT (US)

(21) Appl. No.: 13/897,130

(22) Filed: May 17, 2013

Related U.S. Application Data
(60) Provisional application No. 61/648,310, filed on May 17, 2012.

(51) Int. Cl. G06F 19/00

(52) U.S. Cl. CPC G06F 19/322
USPC 705/2

(57) ABSTRACT

In a system for remote storage of clinical data, the system includes a server, a database in communication with the server, wherein clinical data is stored on the database. The system includes a communication link between the server and a network. The server executes software to securely generate, receive, store, update, provide access to and/or transmit the clinical data between and among patients, healthcare providers and other authorized parties including members and administrators of the system.

### CROSS REFERENCE TO RELATED APPLICATIONS

This application is related to and claims the benefit of U.S. Provisional Patent Application No. 61/648,310, entitled “System and Method for Remote Storage of Clinical Data and for Providing Access Thereto,” filed on May 17, 2012, the disclosure of which is incorporated by reference herein in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### BACKGROUND OF THE INVENTION

1. Field of the Invention

The present invention relates to a system and method for remote storage of clinical data and for providing secure access thereto. More specifically, the present invention relates to a system and method for receiving clinical data associated with a patient from one or more healthcare providers, storing the received clinical data associated with the patient, providing secure access to the clinical data, and/or transmitting the clinical data in accordance with instructions from the patient.

2. Background of the Invention

Healthcare providers generate, store and update clinical data associated with one or more patients. A typical patient interacts with a plurality of unaffiliated healthcare providers. For example, a typical patient may interact with a general practitioner, one or more unrelated specialists, one or more laboratories, one or more hospitals or other medical facility or institution, and/or one or more insurance companies or payment agencies. Clinical data generated by each of these healthcare providers is typically stored at a plurality of remote and/or diverse locations using incompatible systems and methods. For example, while some healthcare providers may use electronic data storage systems, other healthcare providers may maintain only paper records, or have a portion of their relevant records on paper or otherwise not be suitable for electronic storage and/or comprehension (e.g., readable by humans and/or contemporary equipment). Clinical data generated and stored by a first healthcare provider is typically not stored in a data format that is compatible with a data storage system maintained by a second healthcare provider. Likewise, clinical data generated by a first healthcare provider is generally not provided to a second healthcare provider. As a result, it is difficult and time consuming for a first healthcare provider treating a patient to receive data from a second healthcare provider regarding the patient, where the data is necessary and/or useful for the first healthcare provider to treat the patient.

As described herein, clinical data includes any data related to the provision of a healthcare service to a patient. Clinical data may include, for example, data related to and/or indicative of the condition of a patient, observations of a patient made by a healthcare provider, a patient's medical history, insurance coverage of a patient, billing and payment information, prescribed courses of action for treating a patient, and data related to and/or indicative of results of medical tests performed on a patient. A person of ordinary skill in art should recognize that the above definition is a non limiting example, and clinical data may include additional categories of data related to the provision of a healthcare service to a patient.

A clinical data record of a patient comprises clinical data associated with the patient that is generated and stored by one or more healthcare providers. Using known data storage systems, it is difficult to provide access to a comprehensive clinical data record of a patient at least because, as discussed above, different components of the clinical data are stored by different healthcare providers in remote locations using incompatible data storage systems. The failure to provide a comprehensive clinical data record hinders a healthcare provider's treatment, increases the risk to the patient, and increases the cost and inefficiency associated with providing treatment of the patient. Furthermore, as a result of the existing infrastructure, it is difficult for a patient to monitor and control access to his/her own clinical data.

Accordingly, the inventor has recognized that a need exist for an improved system and method for securely generating, receiving, storing, updating, providing access to and/or transmitting clinical data between and among patients, healthcare providers and other authorized parties including members and administrators.

### SUMMARY OF THE INVENTION

The present invention resides in one aspect in a system and method for remote storage of clinical data and for providing access thereto. The system includes a server. The server is in communication with a database. Clinical data is stored in the database. The server is in communication with the Internet. Software executing on the server retrieves clinical data associated with a first patient from one or more healthcare providers associated with the first patient. Software executing on the sever stores the received clinical data in the database. In some embodiments, the system retrieves and stores clinical data of a first patient from a plurality of unaffiliated healthcare providers. The system further includes software executing on the server for receiving a request for clinical data of the first patient. Software executing on the server retrieves clinical data from the database in response to the request. Software executing on the server transmits the retrieved data in accordance with the request.

### BRIEF DESCRIPTION OF THE DRAWINGS

FIG. 1 is a schematic block diagram of an exemplary system for securely generating, receiving, storing, updating, providing access to and/or transmitting clinical data between and among patients, healthcare providers and other authorized persons, in accordance with one embodiment of the present invention.

FIG. 2 is a simplified schematic block diagram of a computing device operative by a patient or healthcare provider, in accordance with one embodiment of the present invention.

FIGS. 3A to 3D depict exemplary graphical user interfaces (GUIs) implementing a Patient home page GUI of the system of FIG. 1, in accordance with one embodiment of the invention.

FIG. 4 depicts exemplary GUI implementing a Patient Access GUI of the system of FIG. 1, in accordance with one embodiment of the invention.

FIGS. 5A and 5B depict exemplary notification messages of the system of FIG. 1, in accordance with one embodiment of the invention.

FIG. 6 depicts exemplary GUI implementing a Provider Access GUI of the system of FIG. 1, in accordance with one embodiment of the invention.

FIG. 7 depicts exemplary GUI implementing a Provider Request Access GUI of the system of FIG. 1, in accordance with one embodiment of the invention.

FIGS. 8A to 8C depict exemplary notification messages of the system of FIG. 1, in accordance with one embodiment of the invention.

FIG. 9 depicts exemplary GUI implementing a Permissions Screen GUI of the system of FIG. 1, in accordance with one embodiment of the invention.

FIGS. 10 to 12 depict exemplary GUIs implementing the system of FIG. 1, in a Providers office or practice.

FIG. 13 depicts exemplary GUI implementing a Compose Message GUI of the system of FIG. 1, in accordance with one embodiment of the invention.

FIG. 14 depicts exemplary GUI implementing a Message Queue GUI of the system of FIG. 1, in accordance with one embodiment of the invention.

### DETAILED DESCRIPTION OF PREFERRED EMBODIMENTS OF THE INVENTION

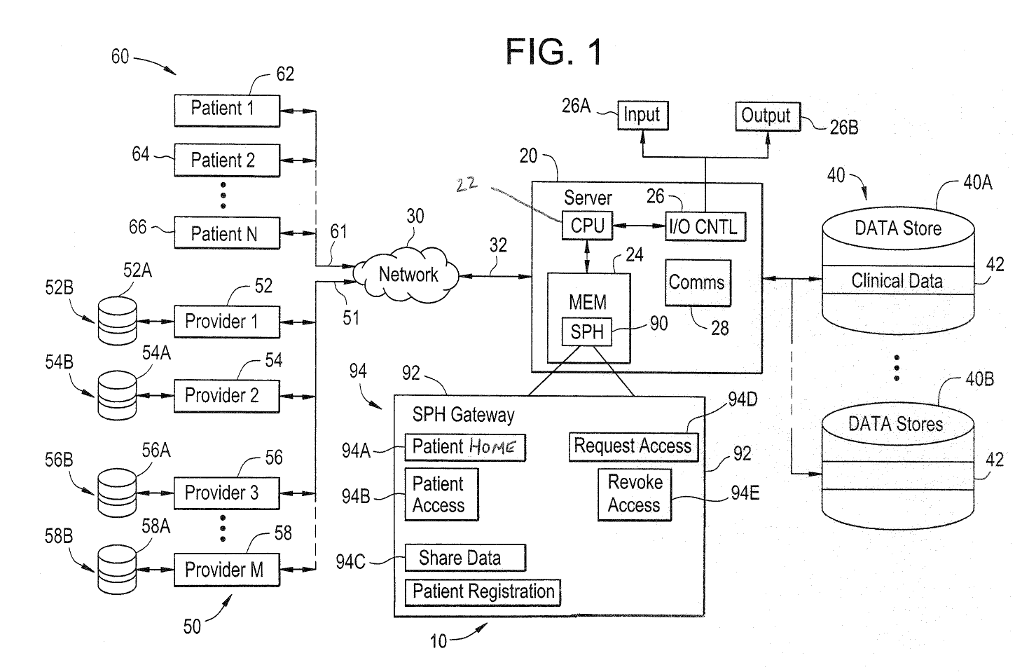

In reference to FIG. 1, an exemplary embodiment of a system, shown generally at 10, configured and operating to provide securely generate, receive, store, update, provide access to and/or transmit clinical data between and among patients, healthcare providers and other authorized parties including members and administrators of the system 10. The system 10 includes a server 20 having a central processing unit (CPU) 22, memory 24 that can include random access memory (RAM), read only memory (ROM), a hard drive (HD), and the like, an input/output controller (I/O CNTRL) 26 operatively coupled to input 26A and output 26B devices such as a keyboard, mouse, light pen or other pointing device, a document, card or other medium reader or scanner, a printer, a monitor or other display device for facilitating input to and output from the system 10 of data and information, and an electronic communication apparatus (COMMS) 28 for communicating, as indicated by reference numeral 32, with a computerized communication network 30 such as, for example, the Internet, an intranet, an extranet, or like distributed communication platform connecting computing devices over wired and/or wireless connections. It should be appreciated that the term server generally refers to one or more computing devices for use with the present invention. The server 20 may comprise, for example, a standalone computing device and/or two or more computing devices operatively connected and functioning together to perform computer implemented functions and algorithms as described herein. As shown in FIG. 1, the server 20 includes and executes one or more software modules or agents 90, referred to hereinafter as Simplicity Personal Health (SPH) module 90, as described herein. SIMPLICITY is a trademark of IQ-EQ Systems LLC (New Haven, Conn. USA).

The system 10 includes one or more data storage devices 40 (e.g., data storage devices 40A, 40B shown) for storing clinical data 42 available within the system 10. In one embodiment, the clinical data 42 is stored as one or more records within one or more databases. The one or more data storage devices 40 are in communication with the server 20 directly (as illustrated in FIG. 1) or through the network 30. Software executing on the server 20, such as the SPH module 90, accesses and manages the clinical data 42 as it is generated, received, stored, updated, made available for access and/or transmitted between and among patients, healthcare providers and other authorized parties of the system 10, within guidelines, permissions and like authorizations implemented by the system 10. In some embodiments, the server 20 and the data storage devices 40 are located in the same location, for example, in a same building. In other embodiments, the server 20 and the data storage devices 40 are located in remote locations and are connected by the network 30.

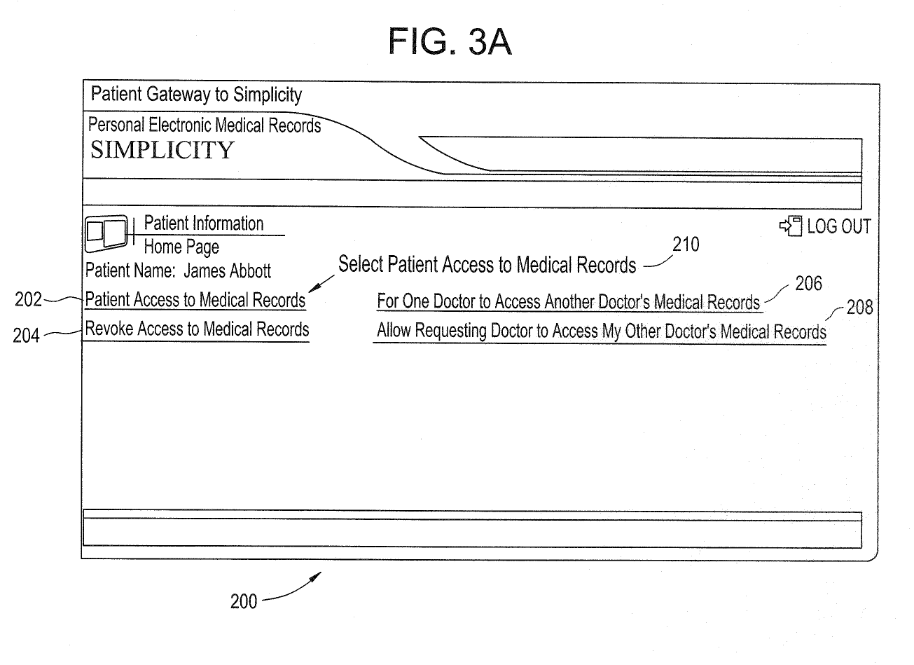

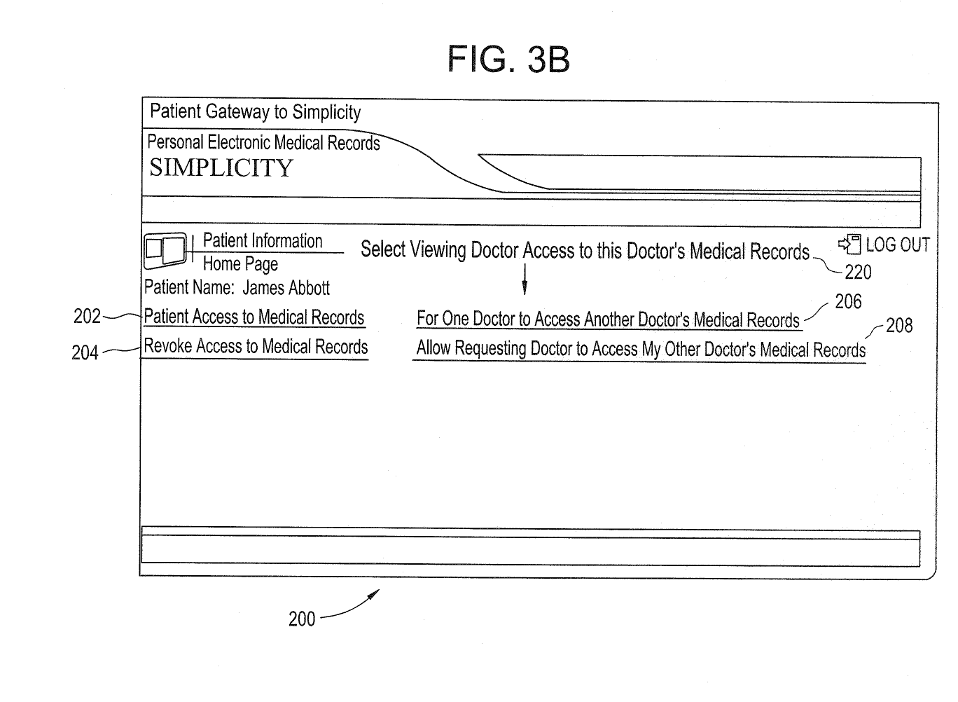

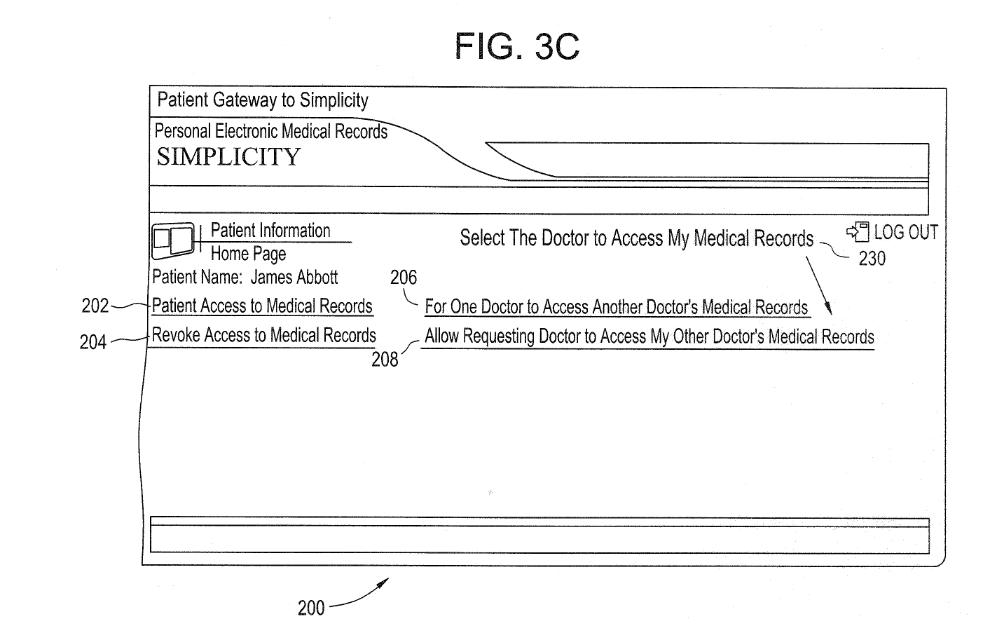

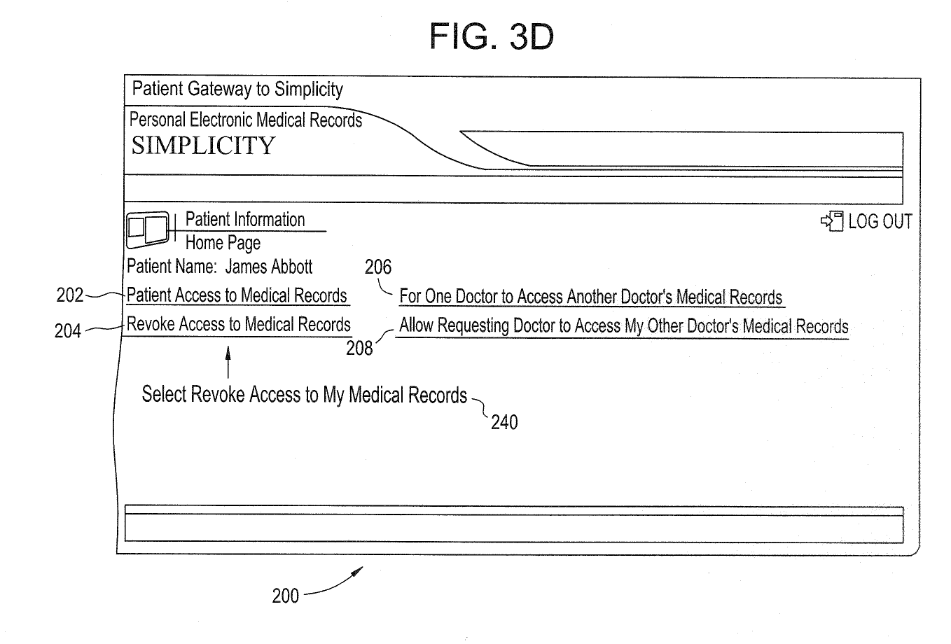

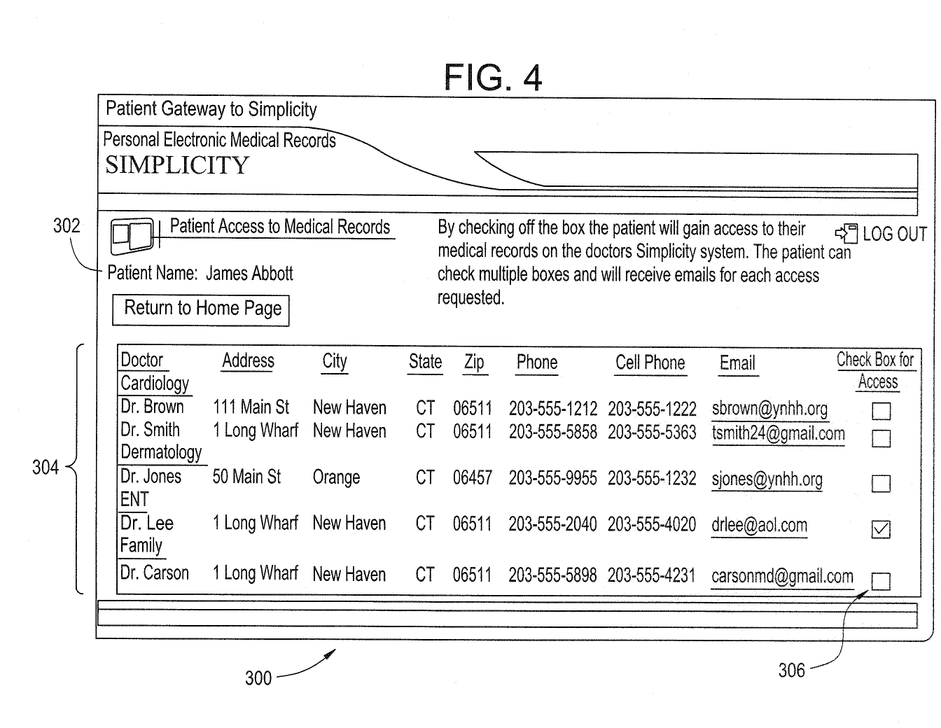

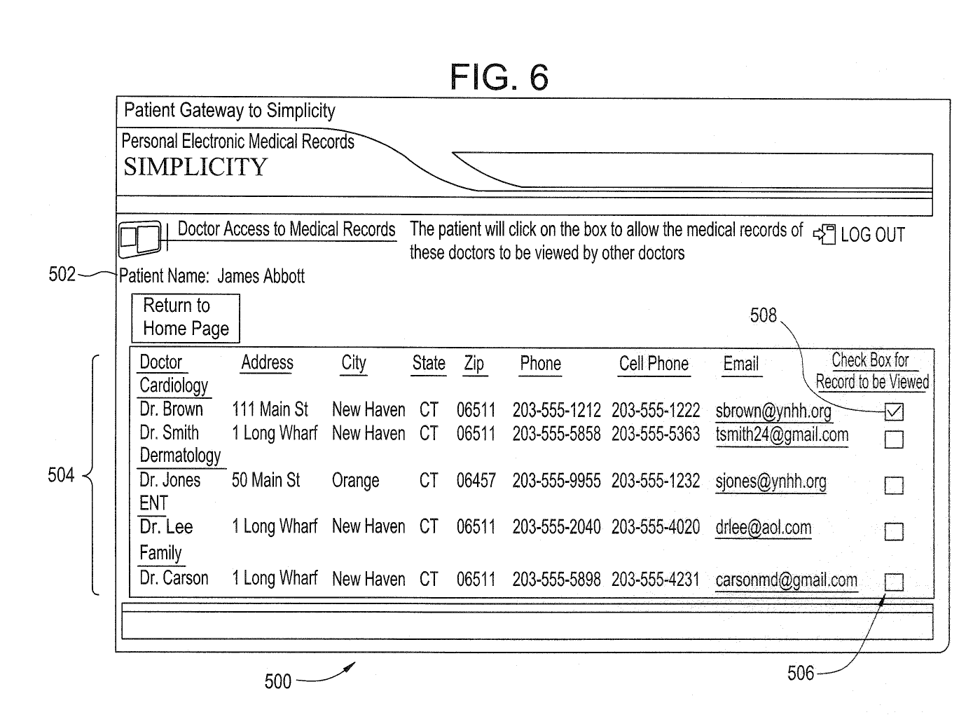

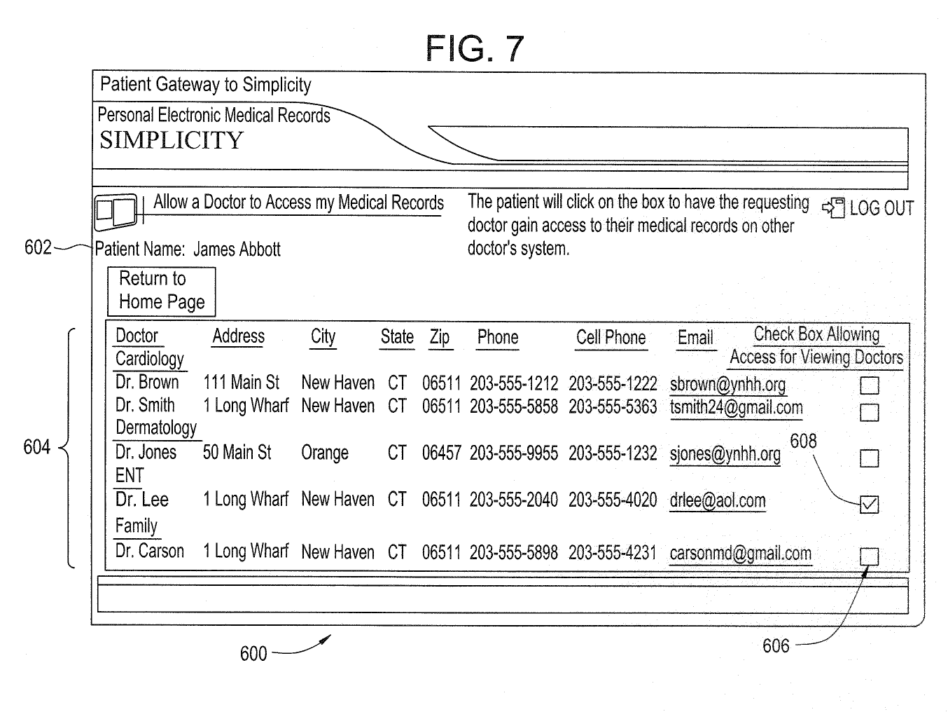

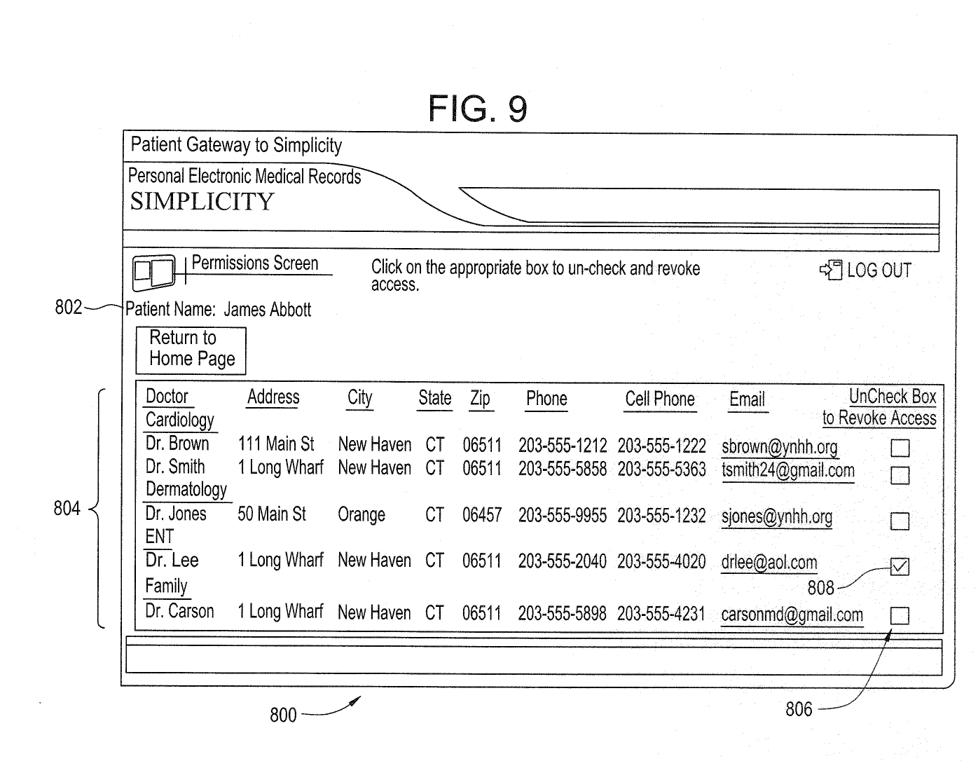

As shown in FIG. 1, the server 20 through execution of the SPH module 90, generates a user interface 92, referred to herein as a Simplicity Personal Health (SPH) Gateway 92. In one embodiment, the SPH Gateway 92 includes a plurality of graphical user interfaces (GUIs) 94 including, for example, a Patient home page GUI 94A (FIG. 3), a Patient Access GUI 94B (FIG. 4) providing features and functions by which a patient gains access to their clinical data stored in data storage devices of the system 10, an Authorized Provider to Share Data GUI 94C (e.g., Doctor Access GUI of FIG. 6) providing features and functions by which a patient authorizes a care provider (e.g., a doctor, nurse, paramedical staff, administrator and the like, and combinations thereof) to make the patient's clinical data stored by the provider available for review by other authorized providers, an Authorized Provider to Request Access GUI 94D (e.g., Doctor Request Access GUI of FIG. 7) providing features and functions for by which a patient authorizes a care provider (e.g., a doctor, nurse, paramedical staff, administrator and the like, and combinations thereof) to request access to the patient's clinical data stored by another provider available for review, and a Revoke Access GUI 94E (e.g., Permissions Screen GUI of FIG. 9) providing features and functions by which a patient suspends or withdraws, temporarily, for a period of time, or until manually updated) authorization to share or request access to their clinical data 42 stored in data storage devices 40 of the system 10.

As described herein, the plurality of GUIs 94 may be provided to the patient as part of a standalone version of the SPH module 90 installed on a single client device (as described below) or network version of the SPH module 90 provided by the server 20, e.g., one instance of which executing at a dedicated client device. In one embodiment, the SPH module 90 and GUIs 94 may be provided as a web site requested through designation of a Uniform Resource Locator (URL), providing access to the server 20 from other computing devices over the network 30. In one embodiment, access to the SPH module 90, GUIs 94, clinical data 42, and/or selected portions thereof, and/or to selected services and functionality provided by the SPH module 90 or system 10, is restricted to registered (e.g., “member”) patients, healthcare providers, and other authorized parties, institutions and administrators of the system 10, as is described herein, executing programs such as, for example, web browser software to request, receive and process the SPH module 90.

In reference to FIG. 1, the system 10 includes a plurality of healthcare providers 50 operating healthcare provider computing devices 52, 54, 56 and 58 and, in accordance with the present invention, communicating as indicated by reference numeral 51, with the server 20 over the network 30. It should be appreciated that the healthcare providers 50 may include, but are not limited to, a general practitioner, a physician, a hospital, a laboratory facility, a medical testing center, a pharmacy, an insurance company, a government agency and other authorized parties. Many healthcare providers maintain an electronic data storage system, operative with their respective computing device, for storing clinical data associated with a patient. For example, as shown in FIG. 1, a first healthcare provider, such as a physician, operates his/her computing device 52 to access a data storage device 52A coupled thereto and clinical data 52B stored therein. Similarly, a second healthcare provider, such as an insurance company, operates its computing device 54 to access a data storage device 54A storing clinical data 54B therein, a third healthcare provider, such as a laboratory facility, operates its computing device 56 to access a data storage device 56A storing clinical data 56B therein, a fourth healthcare provider, such as a hospital or other medical facility, operates its computing device 58 to access a data storage device 58A storing clinical data 58B therein. As shown in FIG. 1, the computing devices 52, 54, 56 and 58 and the data storage devices 52A, 54A, 56A and 58A are in communication with the network 30. As such, the server 20 can communicate with and access the data storage devices the data storage devices 52A, 54A, 56A and 58A maintained by the one or more health care providers 50 and the clinical data 52B, 54B, 56B and 58B stored therein.

In further reference to FIG. 1, one or more patients 60 can access the clinical data 42 stored on the system 10 using a computing device 62, 64 and 66. It should be appreciated that, as used herein, the term “patient” refers to a person being provided with healthcare and any other person legally entitled and authorized by the system 10 to access the clinical data 42 of the person being provided with healthcare such as, for example, a parent, guardian, institutional or governmental authority, or attorney-in-fact. It should be appreciated that in one embodiment the patient computing devices 62, 64 and 66 are “thin client” computing devices, for example, a computing that depends on the server 20 to provide functionality. In one embodiment, a patient computing device may include, but is not limited to, a portable computing device such as, for example, a personal digital assistant (PDA), smart phone such as a BlackBerry, iPhone, or the like, an iPad, an Android device, a terminal computer, a tablet or notebook computer, or any other known device that is capable of executing a browser program or other application for communicating over the network 30.

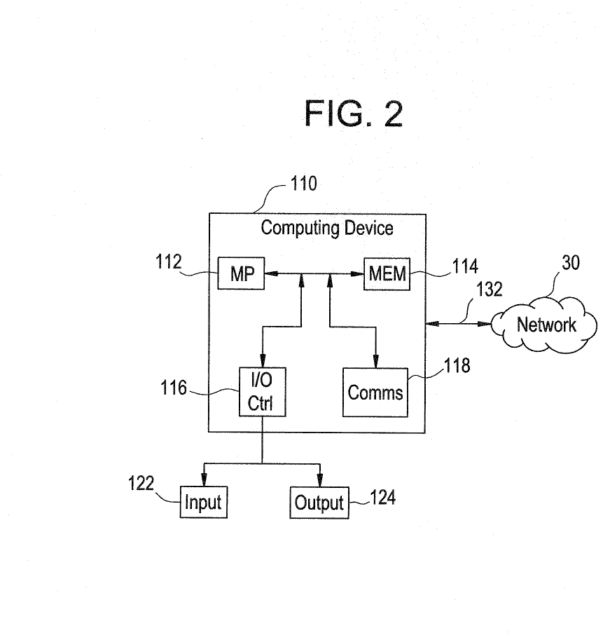

As shown in FIGS. 1 and 2, in one embodiment, the healthcare provider computing devices 52, 54, 56 and 58 and the patient computing devices 62, 64 and 66, may be configured as a computing device 110 including a processor (MP) 112, an input-output controller (I/O CNTRL) 116 operatively coupled to input 122 and output 124 devices such as, for example, a keyboard, mouse, light pen or other pointing device, a document, card or other medium reader or scanner, a printer, a monitor, touch sensitive screen or other display device for facilitating input to and output from the system 10 of data and information, memory 114 that can include RAM, ROM, a hard drive and the like, and a communication apparatus (COMMS) 118 for communicating with server 20 over the network 30. In one embodiment, the COMMS 118 can include a transmitter/receiver, a modem or other connection device capable of establishing a path 132 to the network 30 through a wired or wireless communication line such as a telephone network, television cable lines, satellite links, DSL lines, or the like. In one embodiment, the computing device 110 may be an IBM-type or Apple Personal Computer, or compatible devices, suitable for running a browser program for accessing and communicating with the network 30 including, for example, a workstation, laptop, notebook, tablet or other portable computing devices such as an iPad, smart phone, or the like.

As discussed above clinical data 42 is stored on the data store 40 of the system 10. Each component of clinical data 42 is associated with at least one patient identifier. The patient identifier may include, but is not limited to, the name of a patient, or a unique alpha-numeric sequence associated with the patient such as, for example, a social security number, a tax identification number, an insurance number or the like.

Referring again to FIG. 1, data gathered or generated during the treatment of a patient is input to the system 10. For example, prior to treatment, one of the patients 60 operating one or more of the computing devices 62, 64, 66 may input clinical data including for example, a patient's medical history, insurance information and the like, to one or more healthcare provider devices 50, for initial local storage, or may input clinical data to the server 20 for storage in the data store 40. Similarly, prior to or during treatment, one of the healthcare providers 50 operating one or more of the computing devices 52, 54, 56 and 58 may input clinical data including for example, observations and/or test results made or derived when treating the patient, and the like, to the healthcare provider storage devices 52A, 54A, 56A and 58A. Accordingly, the system 10 includes hardware and software components for generating, receiving, storing, updating, making available for access and/or transmitting clinical data between and among patients, healthcare providers and other authorized parties of the system 10, within guidelines, permissions and like authorizations implemented by the system 10.

For example, the system 10 includes software 90 executing on the server 20 for retrieving clinical data 42, 52B, 54B, 56B, and 58B associated with a first patient from one or more healthcare providers associated with the first patient. In one embodiment, the first patient transmits a command to the system to retrieve clinical data from a healthcare provider. For example, a patient may visit a healthcare provider operating provider computing device 52. During the visit, the healthcare provider generates clinical data 52B related to the treatment of the first patient. This clinical data is stored on the electronic data storage system 52A associated with the first healthcare provider's device 52. After the visit, the first patient logs on to the system 10 using one of the patient computing devices 62, 64 and 66. The first patient transmits an indication to the server 20 that the first patient visited the first healthcare provider. In response to such an indication, software 90 executing on the server 20 generates a request for clinical data 52B generated by the first healthcare provider during the patient visit. Software 90 executing on the server 20 transmits the request for clinical data 52B to the first healthcare provider through the network 30. When the first patient logs on to the system 10, the SHP module 90 presents the Patient home page GUI 94A, implemented as a Patient Information GUI 200 of FIGS. 3A-3D. As illustrated generally at 210 of FIG. 3A, a “Patient Access to Medical Records” icon or button 202 may be selected on the Patient Information GUI 200. In response, the SHP module 90 presents the Patient Access GUI 94B, implemented as a Patient Access to Medical Records GUI 300 of FIG. 4. As shown in FIG. 4, in one embodiment, the patient Mr. Abbott, identified at 302, is presented one or more fields 304 including, for example, a list of his/her healthcare providers organized by, for example, specialty. By selecting, shown generally at 306, one or more of the healthcare providers with the fields 304 (e.g., Dr Lee—ENT), the patient 302 gains access to his/her clinical data 52B stored by the healthcare provider's devices 52 and 52A. In one embodiment, the data storage device 52A associated with the healthcare provider 52 (e.g., Dr. Lee) receives the clinical data request from the server 20. Software executing on selected healthcare provider's device 52 and the data storage device 52A processes the request and retrieves clinical data 52B responsive to the request. Software executing on the computing device 52 associated with the first healthcare provider generates a reply to the request for clinical data. The reply includes the clinical data responsive to the request that is transmitted to the server 20 over the network 30 for storage as the clinical data 42 of the data storage device 40 (FIG. 1). For example, the system 10 includes software executing on the server 20 for receiving the reply from the clinical data storage device 52A associated with the first healthcare provider's device 52. The system 10 extracts the clinical data associated with the first patient, associates a patient identifier of the first patient with the received clinical data, and stores the clinical data 42 in the data store 40.

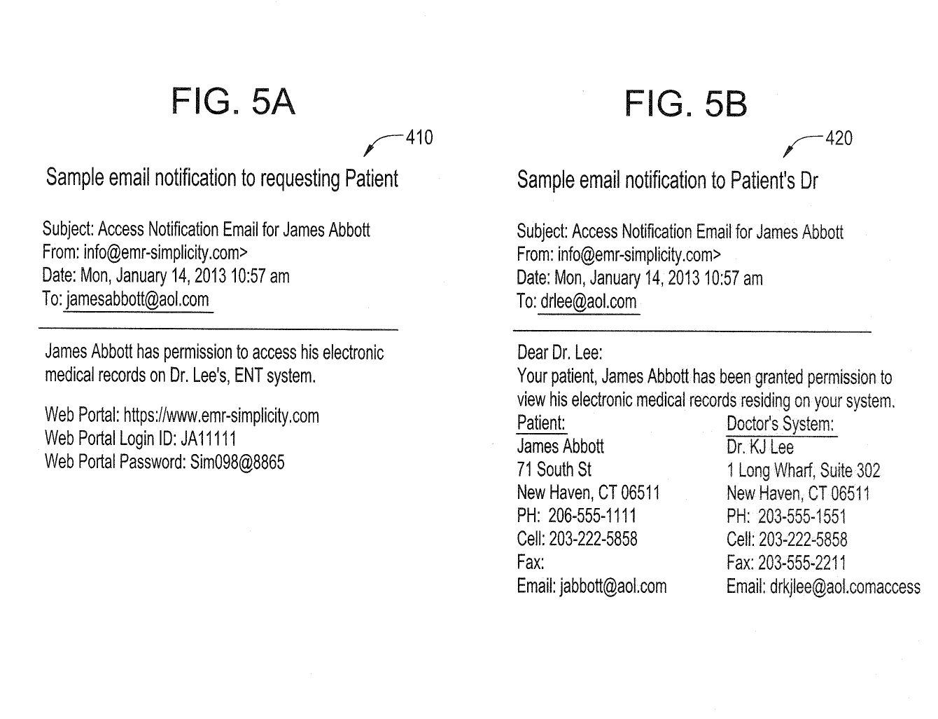

In one embodiment, illustrated in FIGS. 5A and 5B, notifications such as, for example, notification electronic mail (email) messages 410 and 420 are generated by the SPH module 90 and sent to the requesting patient (e.g., the first patient, Mr. Abbott 302) and the first healthcare provider (e.g., Dr KJ Lee). In some embodiments, the patient does not initiate a request to retrieve clinical data from a health care provider. For example, in some embodiments, the first patient provides her patient identifier to the healthcare provider during a visit. For example, the patient identifier may be printed on the first patient's insurance card. Based on this patient identifier, the healthcare provider understands that the patient is enrolled in the system 10. Based on this information, the healthcare provider transmits clinical data 52B associated with the treatment of the first patient to the system 10 without waiting for a request for such clinical data from the server 20. This configuration is seen as beneficial at least because it does not require the patient to instruct the system 10 to retrieve clinical data and send it to the server 20 each time the patient visits a healthcare provider.

In some embodiments, an insurance company or government body (e.g., providers operating devices 54 and 56) initiates the collection of clinical data 42 associated with a first patient. For example, a first patient may have coverage from an insurance company. It is customary for the first patient to identify the insurance company operating device 54 to a healthcare provider operating computing device 52 who is treating the first patient. The insurance company communicates using 54 with the healthcare provider 52 to provide insurance coverage for the first patient and to pay costs associated with covered healthcare. As a result, the insurance company is generally aware of the healthcare provider that treats a first patient. After the insurance company becomes aware healthcare was provided, and consequently that clinical data 52B is being generated and stored at 52A, the insurance company instructs the healthcare provider 52 to transmit the relevant clinical data 52B associated with health care provided to a first patient to the system 10 for storage as clinical data 42, in accordance with the present invention. As such, the insurance company operating device 54 can access the clinical data 42 through communication with the server 20. In other embodiments, the insurance company communicates with software executing on the server 20, instructing the system 10 to generate and transmit a request for the clinical data 52B stored by healthcare provider at data store 52A.

As described in the background section of the present disclosure, in some cases a first healthcare provider maintains clinical data in a first format while the server 20 and data store 40 maintains and manipulates the clinical data 42 in a second format. The system 10 includes one or more software modules for converting clinical data stored in the first format to clinical data stored in a second format. Typically, the second format is a standard data format employed by the server 20. In this way, the system can communicate clinical data with different clinical data storage systems maintained by health care providers wherein different data formats are used. The data conversion modules, therefore, allow the system of the present invention to integrate and communicate with a number of legacy systems, competing systems, and proprietary systems maintained by third party healthcare providers.

In some cases, a healthcare provider does not employ an electronic data storage system, or maintains an isolated electronic data storage that is not readily capable of communicating over a network. In such cases, the healthcare provider typically maintains paper records associated with a treatment of a first patient or can readily generate such paper records. To incorporate such paper records into the system 10, the records may be scanned and converted into electronic files utilizing input devices at the healthcare provider computing device 52, or input devices 26A of the server 20. Software executing on the server 20 stores the scanned electronic files, which includes the clinical data 42, on the data store 40. In one embodiment, software executing on the server 20 extracts clinical data 42 from the electronic files and stores it in the data store 40 in a format compatible with the system 10. In this way, a clinical data record associated with a first patient is collected and stored on a central location, e.g., on the data store 40. The clinical data 42 is associated with a first patient identifier, and may include one or more clinical data 52B, 54B, 56B and 58B generated by unaffiliated healthcare providers using different data storage systems which may store data in formats that are not compatible. Through the central storage of clinical data 42, a more comprehensive clinical data record of the first patient is centrally stored, and is securely and readily accessible by interested and authorized parties within the system 10. The clinical data record is more comprehensive in that it includes clinical data generated by a plurality of unaffiliated third party healthcare providers.

With reference to FIG. 3B, the patient selectively authorizes a healthcare provider to allow the patient's clinical data to be available for review by authorized providers. For example, the patient logs on to the system 10 and the SHP module 90 presents the Patient Information GUI 200. As illustrated generally at 220 of FIG. 3B, a “For One Doctor to Access Another Doctor's Medical Records” icon or button 206 may be selected on the Patient Information GUI 200. In response, the SHP module 90 presents the Authorized Provider to Share Data GUI 94C, implemented as a Doctor Access to Medical Records GUI 500 of FIG. 6. As shown in FIG. 6, in one embodiment, the patient (e.g., Mr. Abbott identified at 502) is presented one or more fields 504 including, for example, a list of his/her healthcare providers organized by, for example, specialty. By selecting, shown generally at 506, one or more of the healthcare providers (e.g., Dr. Brown, identified at 508) within the fields 504, the medical records, e.g., clinical data 54B stored by the healthcare provider's devices (Dr. Brown's devices) 54 and 54A, is made available for viewing by other authorized healthcare providers. In one embodiment, selection of healthcare provider triggers the server 20 to request and oversee a transfer of the clinical data 54B to the central store device 40 as the clinical data 42.

With reference to FIG. 3C, the patient selectively authorizes a healthcare provider to request access to the patient's clinical data available for review by authorized providers. For example, as illustrated generally at 230 of FIG. 3C, an “Allow Requesting Doctor to Access My Other Doctor's Medical Records” icon or button 208 may be selected on the Patient Information GUI 200. In response, the SHP module 90 presents the Authorized Provider to Request Access GUI 94D, implemented as a Doctor Request Access GUI 600 of FIG. 7. As shown in FIG. 7, in one embodiment, the patient (e.g., Mr. Abbott identified at 602) is presented one or more fields 604 including, for example, a list of his/her healthcare providers organized by, for example, specialty. By selecting, shown generally at 606, one or more requesting ones of the healthcare providers within the fields 606 (e.g., Dr. Lee, identified at 608), the medical records, e.g., previously stored as the clinical data 54B by the healthcare provider's devices (Dr. Brown's devices) 54 and 54A may be viewed by requesting healthcare providers (e.g., Dr. Lee), once authorized by the system 10.

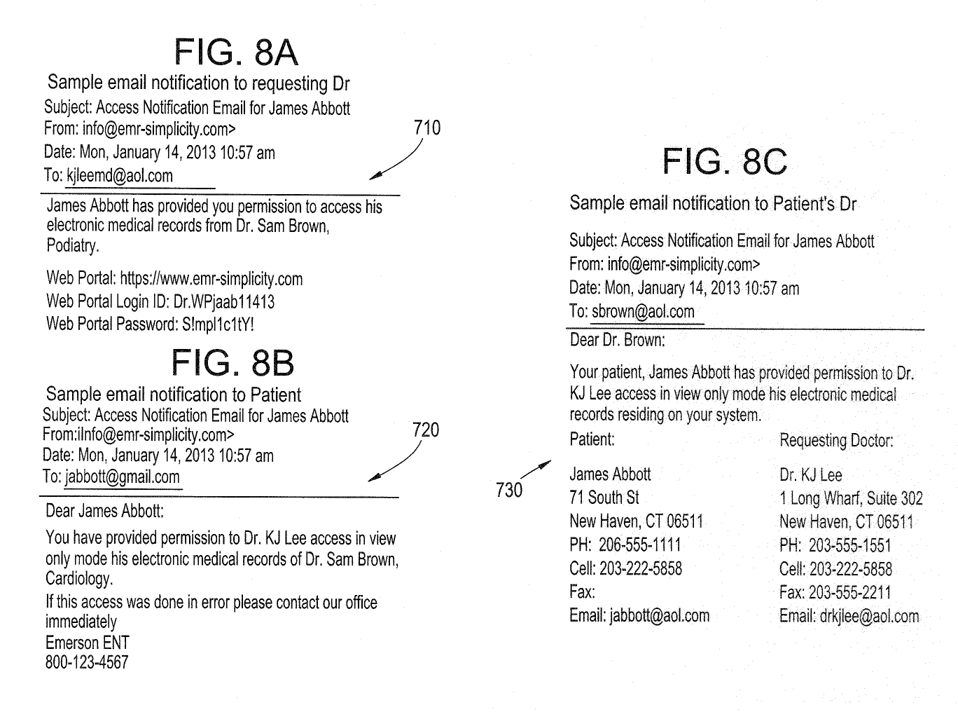

In one embodiment, illustrated in FIGS. 8A, 8B and 8C, notifications such as, for example, notification electronic mail (email) messages 710, 720 and 730 are generated by the SPH module 90 and sent to the requesting doctor (e.g., the first provider, Dr KJ Lee, email 710 of FIG. 8A), the requesting patient (e.g., the first patient, Mr. Abbott, email 720 of FIG. 8B) and the second healthcare provider (e.g., Dr Brown). In some embodiments, the clinical data available for viewing may reside remotely, on the second healthcare providers systems, e.g., clinical data 54B accessed through devices 54 and 54A. Alternatively, the clinical data resides centrally, in the data store 40 as clinical data 42 and is accessible through the server 20.

With reference to FIG. 3D, the patient selectively revokes authorization to his/her clinical data 42 by one or more healthcare providers such that the clinical data residing at the provider is made unavailable for viewing by others, and/or the provider is made unable to request access to the patient's clinical data 42 in the system 10. For example, as illustrated generally at 240 of FIG. 3D, a “Revoke Access to Medical Records” icon or button 204 may be selected on the Patient Information GUI 200. In response, the SHP module 90 presents the Revoke Access GUI 94E, implemented as a Permissions Screen GUI 800 of FIG. 9. As shown in FIG. 9, in one embodiment, the patient (e.g., Mr. Abbott identified at 802) is presented one or more fields 804 including, for example, a list of his/her healthcare providers organized by, for example, specialty. By selecting, shown generally at 806, one or more healthcare providers within the fields 804 (e.g., Dr. Lee, identified at 808), is no longer permitted to request access the patient's clinical data and/or the clinical data 52B stored by the healthcare provider's devices (Dr. Lee's devices) 52 and 52A are not viewable by other requesting healthcare providers (e.g., Dr. Brown).

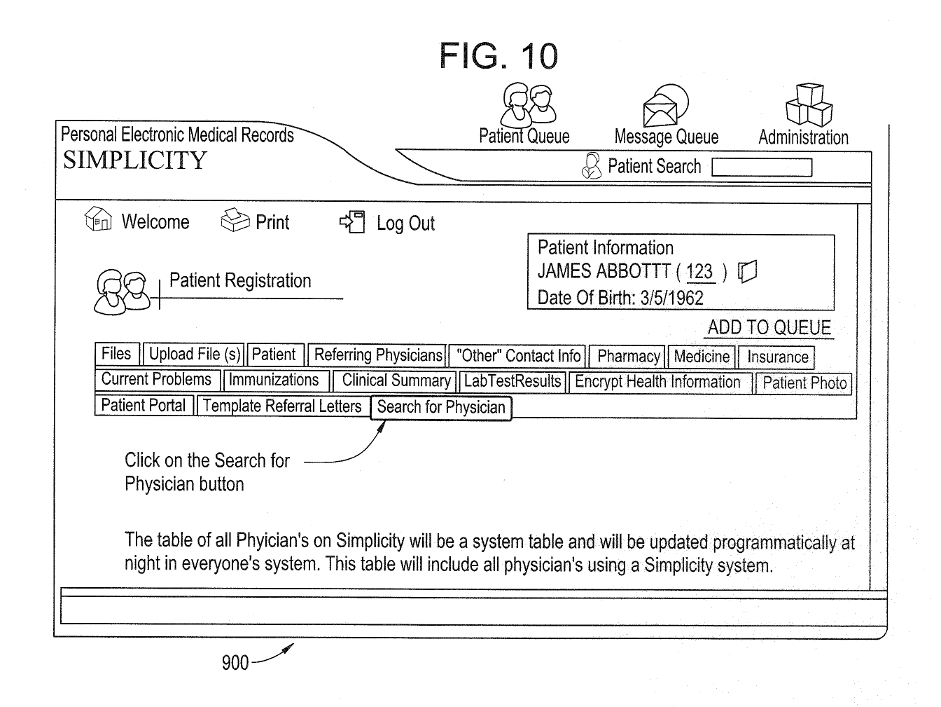

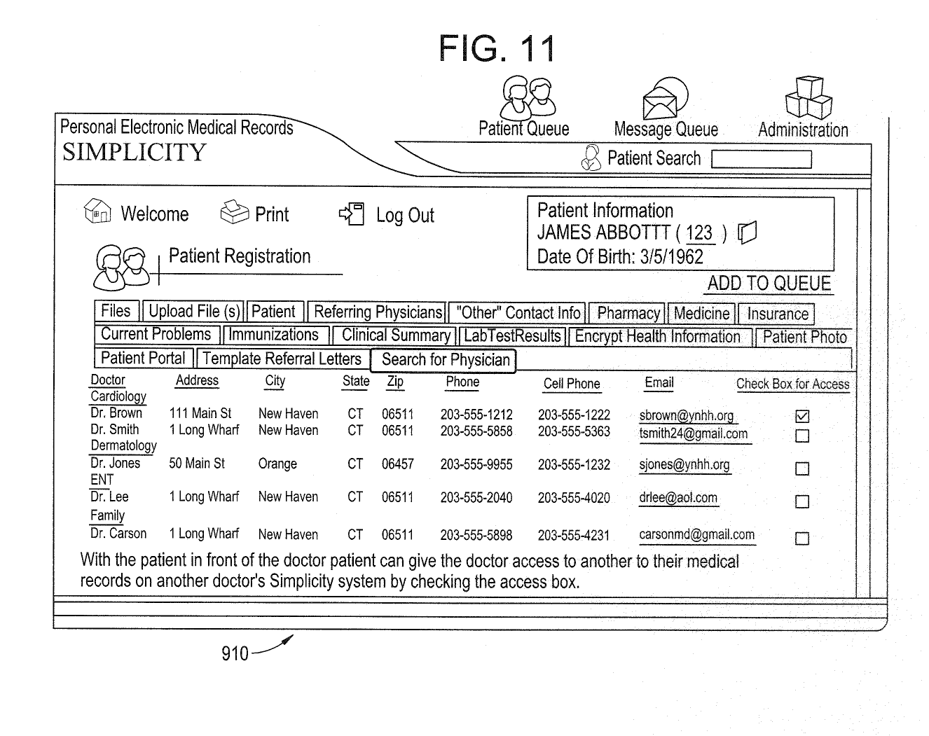

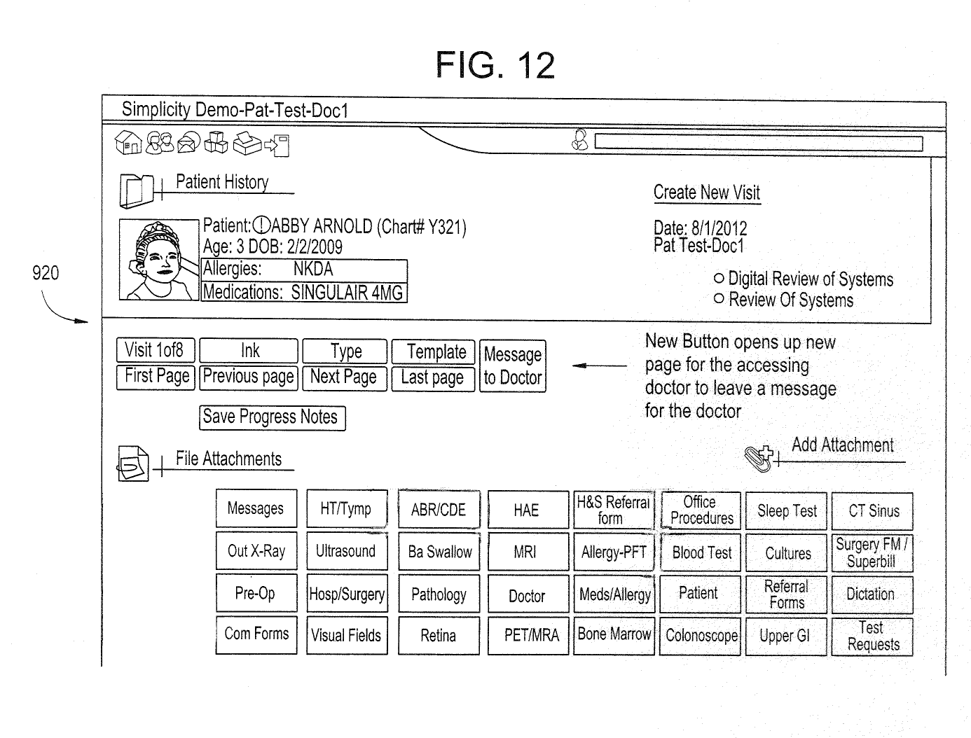

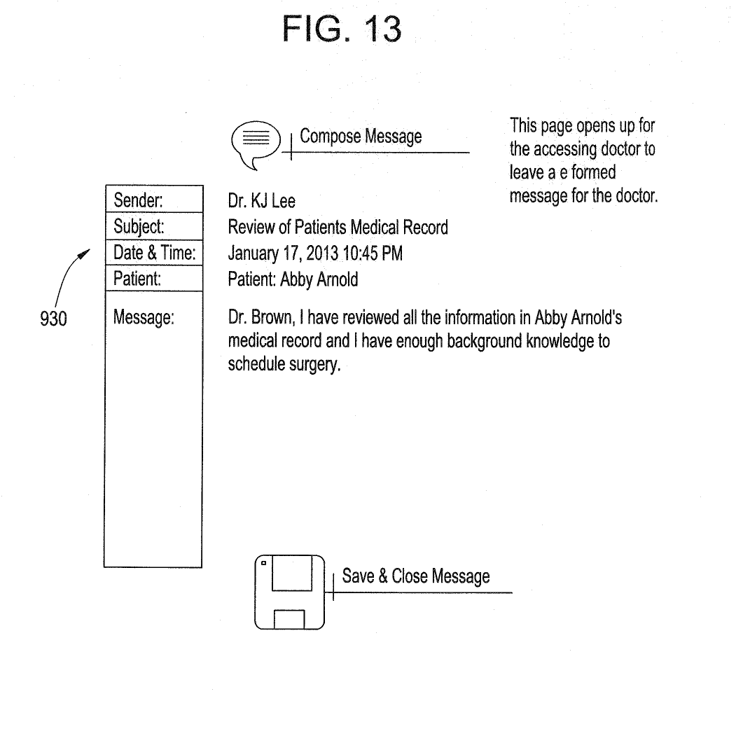

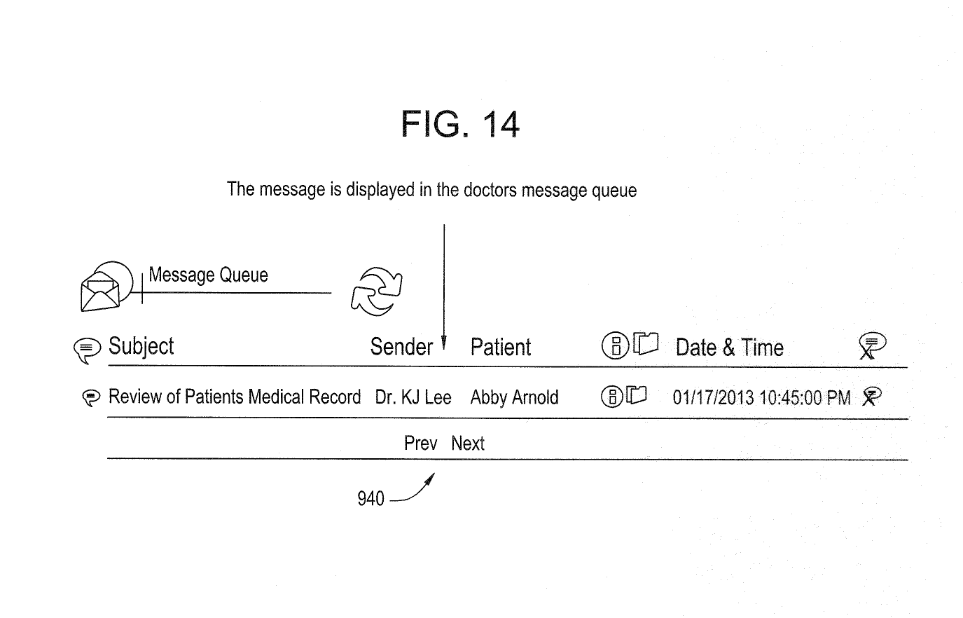

In one embodiment, illustrated in FIGS. 10-14, the system 10 includes GUIs 94 adapted for implementation at a healthcare providers office or practice, and includes a Patient Registration GUI 900 (FIG. 10), providing functionality for launching a search of healthcare providers, e.g., Search for Physician GUI 910 (FIG. 11), a Patient history GUI 920 (FIG. 12) for accessing patient records (e.g., clinical data 42), a Compose Message GUI 930 (FIG. 13) supporting communication between and among patients and healthcare providers within the system 10, and a Message Queue GUI 940 (FIG. 14) for managing communication within the system 10.

In one aspect of the invention, the system 10 includes software executing on the server 20 for accessing and processing a clinical data record of a first patient stored on the database. For example, in some embodiments, the software executing on the server includes a plurality of modules for manipulating the data in accordance with commands received from a patient associated with the data, or a third party having rights to access at least a portion of the clinical data associated with the first patient. Software executing on the server receives commands from a patient computer via the communication network. Software executing on the server generates a log-in screen that is transmitted to the patient computing device. The system requires the patient to log into the system by providing a user name and a password. In some embodiments, the user name is the patient identifier. The patient enters a username and password on the patient computing device. Software executing on the server confirms whether username and password are correct. If the log-in information is correct, the patient is provided access to the clinical data associated with patient identifier that is stored on the database. If the log-in information is incorrect, the system may prompt the patient to re-enter the log-in information, or the system may block patient access.

After a patient is provided access to the system 10, software executing on server is capable of displaying the clinical data record associated with the patient on the GUI of the patient computing device. Software executing on the server generates an interactive display for navigating the clinical data record associated with the first patient. Using the interactive display the first patient can search his clinical data record by different variables. For example, the first patient can sort and search the clinical data record by date of treatment, type of health provider, identity of health care provider, symptoms for which healthcare was sought, tests performed, date the clinical data was generated, etc. It should be understood to a person of skill in the art that the clinical data includes additional components by which the first patient can search and sort her clinical data record.

The system further includes software executing on the server for generating clinical data reports. For example, a patient can instruct the system to generate a report comprising all or a portion of the patient's clinical data record. Software executing on the server receives the instruction, generates a report in accordance with the instruction, and transmits the report, for example a file a Portable Document Format (PDF), to the patient's computer. In some embodiments, the system is capable of generating a certified medical record.

In one embodiment of the present invention, software executing on the server displays a list, in order of date, of visits by a first patient to different health care providers. Each entry on the list represents a visit to a healthcare provider. The patient can select the line, and the system generates a second screen including clinical data specific to that visit to the healthcare provider. The second screen may include, for example, the clinical data generated by the healthcare provider during the visit. Such clinical data may include, but is not limited to, the reason for the visit, a diagnosis made by a healthcare provider during the visit, or a prescribed course of action.

Using the system, the patient can provide authorization to specific healthcare providers to access all or a portion of the patient's clinical data record. For example, a first patient may receive a referral from her primary care physician to see a specialist. Prior to visiting the specialist, the patient can log on to the system over the network, select the specialist, and authorize the specialist to access all or a portion of the first patient's clinical data record. After first patient authorization is received, software executing on the serving generates an authorization notification and transmits the authorization notification to the authorized healthcare provider via the network communication link.

In some embodiments, the authorization notification is an email. The authorization notification email includes an identifier associated with the first patient and an indication that the first patient has authorized the healthcare provider to access all or a portion, of the first patient's clinical data record. In some embodiments, the healthcare provider accesses the server via a computer in response to receiving the notification. The healthcare provider can receive the portion of the clinical data record that the healthcare provider is authorized to access. In some embodiments, the healthcare provider is given a temporary account. In other embodiments, the healthcare provider has a full account, including a username and password. The username and password enables that healthcare provider to login to the system on a periodic basis and access clinical data to which the healthcare provider has been provided access to.

In some embodiments, the authorization notification email includes a hyperlink. Software executing on the server generates a webpage that is accessible through the hyperlink provided to the authorized healthcare professional. In some embodiments, the authorized healthcare professional can only view the clinical data remotely. In other embodiments, the healthcare professional is authorized to download data reports, for example in a PDF format. In yet other embodiments of the present invention, the healthcare professional is authorized to receive the data in a format specified by the healthcare professional, for example, a data format that is compatible with an electronic storage device maintained by the healthcare professional.

It is preferred that after the clinical data is originally received by the system, the data is accessible to the patient and authorized healthcare providers in a read-only format. This prevents one or more parties from altering or deleting the data. This functionality is required by law in most jurisdictions. In some embodiments, the system includes an option of editing data in the system. For example, if clinical data was incorrectly added to a patient's clinical record, that clinical data could be deleted. In such embodiments, it is preferred, although not required, that software executing on the system tracks and record the changes to the clinical data so as a safeguard against tampering with the clinical data. It is further preferred that such write access is limited to specific parties.

Under current medical practices the patient typically has the authority to control and limit access to her clinical data record. However, after a patient provides authorization to a third party to access her clinical data record, the patient is typically not aware of when the authorized party accesses the data, how often that party accesses the clinical data, and what portions of the clinical data record are accessed. The system of the present invention includes software executing on the server that monitors access to clinical data records. The system stores this information in the database. Therefore, the system provides the patient with a more complete understanding of each party that accessed her clinical data, the date and time the clinical data record was accessed, and the portion of the clinical data record that was accessed.

In some embodiments, the patient is provided with a notification that a portion of her clinical data record was accessed. For example, software executing on the server generates a notification email. The system transmits the notification email to the patient. The notification email includes pertinent information relevant to the access to the clinical data record.

In some embodiments of the present invention the clinical data record is encrypted during transmission so as to prevent unauthorized access to the clinical data record. For example, in one embodiment the system employs secure socket layer (SSL) transfers. SSL transfers rely on cryptographic protocols that provide communications securely over a network.

In one embodiment of the present invention, the system includes a software module for converting medical terminology used in the clinical data record into layman terms that are easier for a patient to understand. Typically this conversion module will rely on a database including medical terminology and associated layman terms. In some embodiments, this module is capable of determining a medical diagnosis and prescribed treatment from a clinical data record and providing a layman description of the condition, diagnosis, and prescribed treatment. In some embodiments, the system displays a dropdown menu proximate to the medical terms used in the clinical data record. The patient can select the dropdown menu to obtain a layman term or description associated with the medical term.

In one embodiment of the present invention, the system includes a translation module, wherein the module is capable of translating text included in the clinical data record into a different language. For example, a patient may log on to the system to access her clinical data record on the system. The patient may not speak the language in which the text in the clinical data record was stored. The patient can send an instruction to the system to translate the text into a specific language identified by the patient. For example, the patient may instruct the system to convert the medical text into Spanish. The software module receives the instruction from the patient and subsequently performs the requested translation, and displays the translated text on the patient computer.

In some embodiments of the present invention, the system provides patient metrics that allows a first patient the ability to measure her health. In one embodiment, the system periodically records and stores clinical patient data such as cholesterol, weight, height, age, blood pressure, etc. Software executing on the server generates one or more charts displaying this clinical data associated with the first patient over a period of time thereby allowing the patient to visualize a representation of her health during that time. In yet further embodiments, the system enables the patient to compare her health statistics to known benchmarks, for example a larger population of people.

In some embodiments of the present invention, the system generates one or more health scores for a patient wherein the health score is based on or more pieces of clinical data. The health score is preferably derived using a formula that provides a score indicative of the patient's overall health. Using the health score, the patient can monitor her condition over time and can further monitor her health condition relative to populations that have a similar attributes. In some embodiments of the present invention, software executing on the server generates a patient metric webpage accessible by the patient wherein the patient can access a health score and other related patient metrics.

It is preferred that the present invention is offered, at least to some of the participating healthcare providers and/or patients on a subscription basis. Under the subscription basis, for example, a first healthcare provider will pay subscription payment to the provider of the system. In return, the healthcare provider will have access to clinical data and will be able to store additional patient data on the system. It is envisioned that some healthcare providers will rely entirely on the subscription service to maintain medical records, as opposed to maintaining a separate electronic data storage system. In such scenarios, the healthcare provider may maintain a local backup of the clinical data records stored on the system. Through this subscription model, it is envisioned that the healthcare provider will realize an overall cost savings.

In some embodiments of the present invention, the system provides a referral database. The referral database is stored on the system database and is accessible by the patient and/or healthcare provider via the communication link. The referral database includes a list of specialist, healthcare centers, and other individuals or entities that have special expertise in treating a condition. Through the patient computer, the patient can access the referral database and select one or more specialist to visit in response to a referral.

In yet another embodiment of the present invention, the system queries treatment and medications prescribed to a first patient. The system cross checks the prescribed treatments and medications to ensure that there are not any dangerous interactions with the prescribed treatments and medications.

In one aspect of the present invention, referred to herein as Simplicity Personal Health (“SPH”), a web and mobile based is provided dedicated to simplifying personal healthcare in a time when accessing healthcare, accessing healthcare records, and obtaining insurance reimbursement are becoming more complex and frustrating for the patients. SPH's core feature is a portal that allows patients to store, manage, file, and distribute securely all of their past and present personal health records to care providers, insurance providers, or any others with their mobile phone or computer. The patient is able to log securely into their individual, password protected account, where their records of laboratory tests results, radiographic images, surgery reports, pathology reports etc are kept via cloud. The records can be sorted by any searchable demographic, including but not limited to Specialty, Doctor, Date, File name, etc. With the click of the mouse, their medical records may be sent to any person, regardless of whether or not they subscribe to Simplicity Personal Health.

SPH would also provide for its ever-growing subscribers a daily online community for social media with a ‘health’ twist as a place to share their experiences. For example, besides managing her health records, a newly expecting mother can also come to the site and find out information about her pregnancy as well as connect with local new moms to form new friends and play groups. Further, a user diagnosed with a specific disease can instantly connect with a support group and foundation to learn about potential options for treatment by learning from the experience of the group as a whole. This venue would bring subscribers back to the site daily rather than just when they wish to coordinate their medical records.

The inventors previously filed copending US patent documents outline infrastructure and programming for the organizational file storage and management capability, referred to as the Simplicity EMR, that is leveraged by SPH to provide an electronic medical record system for doctors and nurses which has been storing, filing, and managing over a million medical records of patients since 2006. It includes handwriting recognition software to translate doctors' notes, and will be capable of manipulating the records as structured data.

Accordingly, SPH provides access to anyone with health records or health needs for themselves, elderly relatives or children. The social community provides a daily destination and resource for those looking for communal health information, a support group or a social connection around healthy living. Meanwhile, patients with multiple possible ‘pain’ points such as those with either a budding or bounteous health history, multiple providers, in the process of changing healthcare providers, managing insurance companies, changing jobs, attending school, or even those who travel periodically would benefit greatest from SPH's health record management.

SPH's builds a user base by targeting the thousands of patients whose records currently are already in the Simplicity system as well as the general public to sign up to join the online health social network. SPH also targets Insurance Companies and Health Institutions who would benefit from the reduction of overhead and increase in efficiency by having their customers join the SPH community.

Revenue for the product includes each of the following opportunities:

Fee structure: a one-time signup charge for health record storage (there will be a basic version for users who are able to upload their own records, and a premium version where SPH staff upload user health records); there is no fee to join the community

Targeted ad revenue (targeting enabled by being able to search through records as structured data and chat rooms for key words) from the following exemplary sources:

A. Pharmaceutical companies who wish to advertise their product specifically to those patients who need it (or perhaps who have been prescribed a competitor's product);

B. Health insurance companies who wish to reach patients currently with a competitor by offering them a better premium or better coverage than their existing company

C. Homeopathic and natural distributors or manufacturers; and

D. Gyms selling memberships, local health centers, health food grocers.

Preferably, the system 10 and the SPH module 90 operating therein, is HIPAA compliant. Users are given a unique username and two passwords: one given by SPH and another chosen by the user to ensure complete security. In order for records to be shared, the user will need all of these elements for both desktop access and mobile application access. As copies of records are kept via cloud, there is no risk of privacy infringement if someone loses their mobile device. All clinical data is securely hosted with real time duplication in a separate State and with capability for emergency recapture.

Although the present invention has been disclosed and described with reference to certain embodiments thereof, it should be noted that other variations and modifications may be made, and it is intended that the following claims cover the variations and modifications within the true scope of the invention.

What is claimed is:

1. A system for remote storage of clinical data, said system comprising:
a server;
a database in communication with the server, wherein clinical data is stored on the database;
a communication link between the server and the Internet;
software executing on the server for retrieving clinical data associated with a first patient from one or more healthcare providers associated with the first patient;
software executing on the sever for storing the received clinical data in the database;
wherein the system retrieves and stores clinical data of the first patient from a plurality of unaffiliated healthcare providers.
